(19) United States
(12) Patent Application Publication
(10) Pub. No.: US 2025/0354851 A1
(43) Pub. Date: Nov. 20, 2025

(54) LEVEL METER, LEVEL METER SYSTEM, AND COMMUNICATION ADAPTER FOR LEVEL METER SYSTEM

(71) Applicant: Keyence Corporation, Osaka (JP)

(72) Inventors: Satoru TOMOSHI, Osaka (JP); Tomoya MATSUMOTO, Osaka (JP)

(73) Assignee: Keyence Corporation, Osaka (JP)

(21) Appl. No.: 19/082,226

(22) Filed: Mar. 18, 2025

(30) Foreign Application Priority Data
May 17, 2024 (JP) 2024-080572

(51) Int. Cl. G01F 23/284; G01F 23/80

(52) U.S. Cl. CPC G01F 23/284; G01F 23/802

(57) ABSTRACT

Provided is a level meter that facilitates communication with an external device. The level meter includes a level determination unit and a WEB server. The level determination unit determines a level of a medium in the container. The level meter includes a WEB server that provides a monitor WEB screen showing the level determined by the level determination unit.

### CROSS-REFERENCE TO RELATED APPLICATIONS

The present application claims foreign priority based on Japanese Patent Application No. 2024-080572, filed May 17, 2024, the contents of which are incorporated herein by reference.

### BACKGROUND OF THE INVENTION

### 1. Technical Field

The invention relates to a level meter for measuring a level of a stored object, a level meter system including a level meter, and a communication adapter for a level meter system.

### 2. Description of the Related Art

In a container that stores a flowable substance such as a liquid, a powder, or a particle, a level meter that measures a height of an interface of the substance, that is, a level (liquid level, powder upper surface level, or the like) may be used. Such a level meter has a function of displaying the measured level to a user.

For example, a level meter described in JP2014-002091A includes a display unit that displays the measured liquid level.

In the level meter of JP2014-002091A, a current value of the measured liquid level is displayed as a numerical value on the display unit. Here, in general, what the level meter directly measures is a distance from the level meter to the interface, and in order to convert this distance into a level, information regarding the container (height of the container, or the like) needs to be appropriately set. However, the current value of the level is only displayed, and thus, the user cannot visually grasp whether or not the information regarding the container that is currently set is appropriately set.

In addition, an external device may be connected to the level meter, but the external device needs to have a communication function with the level meter. That is, unless the level meter is an external device compatible with a communication protocol for inputting and outputting signals, a state of the level measured by the level meter cannot be displayed or an operation setting of the level meter cannot be changed.

### SUMMARY OF THE INVENTION

In view of the above problems, an object of the invention is to provide a level meter, a level meter system including a level meter, and a communication adapter for a level meter system, in which settings related to a container are easily visually grasped and communication with an external device is easy.

In order to solve the above problem, a level meter as an example of an embodiment according to the invention includes a detection element, a memory, a level determination unit, a display unit, an operation unit, and a WEB server. The detection element generates a detection signal corresponding to a level of a medium in a container. The memory stores setting information regarding the container. The level determination unit acquires a detection waveform related to a distance and signal intensity based on the detection signal generated by the detection element, and determines the level based on the detection waveform and the setting information. The display unit displays a monitor screen showing the level determined by the level determination unit and a setting screen for setting the setting information. The operation unit receives an operation input for setting the setting information. The WEB server provides a monitor WEB screen showing the level determined by the level determination unit and a diagnosis WEB screen displaying the setting information and the detection waveform in association with each other.

In addition, a level meter system as another example of the embodiment according to the invention includes a level meter, a WEB server, and a communication terminal. The level meter includes a detection element that generates a detection signal corresponding to a level of a medium in a container, a memory that stores setting information regarding the container, a level determination unit that acquires a detection waveform related to a distance and signal intensity based on the detection signal generated by the detection element and determines the level based on the detection waveform and the setting information, a display unit that displays a monitor screen showing the level determined by the level determination unit and a setting screen for setting the setting information, and an operation unit that receives an operation input for setting the setting information. The WEB server communicates with the level meter and provides a monitor WEB screen showing the level determined by the level determination unit and a diagnosis WEB screen displaying the setting information and the detection waveform in association with each other. The communication terminal communicates with the WEB server and operates a WEB browser that displays the monitor WEB screen and the diagnosis WEB screen.

In addition, the communication adapter for a level meter system as still another example of the embodiment according to the invention relays communication from the level meter to the communication terminal in the level meter system described above. The communication adapter for a level meter system includes a WEB server. The communication adapter for a level meter system receives a signal of a first communication protocol output from the level meter, acquires level meter information including the level determined by the level determination unit, the detection waveform, and the setting information, and transmits WEB browser information including the level meter information, data of the monitor WEB screen, and data of the diagnosis WEB screen to the communication terminal according to a second communication protocol received by the communication terminal.

According to the invention, since the setting information regarding the container is displayed in association with the detection waveform, the setting information is easily visually recognized. In addition, since the monitor WEB screen and the diagnosis WEB screen are provided by the WEB server, communication between the external device including the WEB browser and the level meter is easy.

### BRIEF DESCRIPTION OF THE DRAWINGS

FIG. 1 is a diagram schematically illustrating a level meter system;

FIG. 2 is a diagram illustrating a state where a level meter is attached to a container that contains a medium;

FIG. 3 is a block diagram schematically illustrating an example of a relationship between components included in a housing of the level meter;

FIG. 4 is a block diagram schematically illustrating an example of a relationship between components included in a communication adapter of the level meter;

FIG. 5 is a diagram illustrating an example of a monitor WEB screen;

FIG. 6 is a diagram illustrating an example of a diagnosis WEB screen;

FIG. 7 is a diagram illustrating display at the time of execution of an adaptive function;

FIG. 8 is a diagram illustrating an example of a setting WEB screen; and

FIG. 9 is a diagram illustrating an example of a WEB screen for a safety laser scanner.

### DETAILED DESCRIPTION

Hereinafter, embodiments of the invention will be described with reference to the drawings. Note that, in the drawings, the same or corresponding portions are denoted by the same reference numerals, and thus, the description thereof will not be basically repeated. In addition, in the following description, terms meaning positions or directions such as front, back, left, right, upper, and lower may be used, but these terms are used for the sake of convenience to facilitate understanding of the embodiments. These terms are not limited to front, back, left, right, upper, lower, and the like in a geometrically strict sense unless expressly stated otherwise.

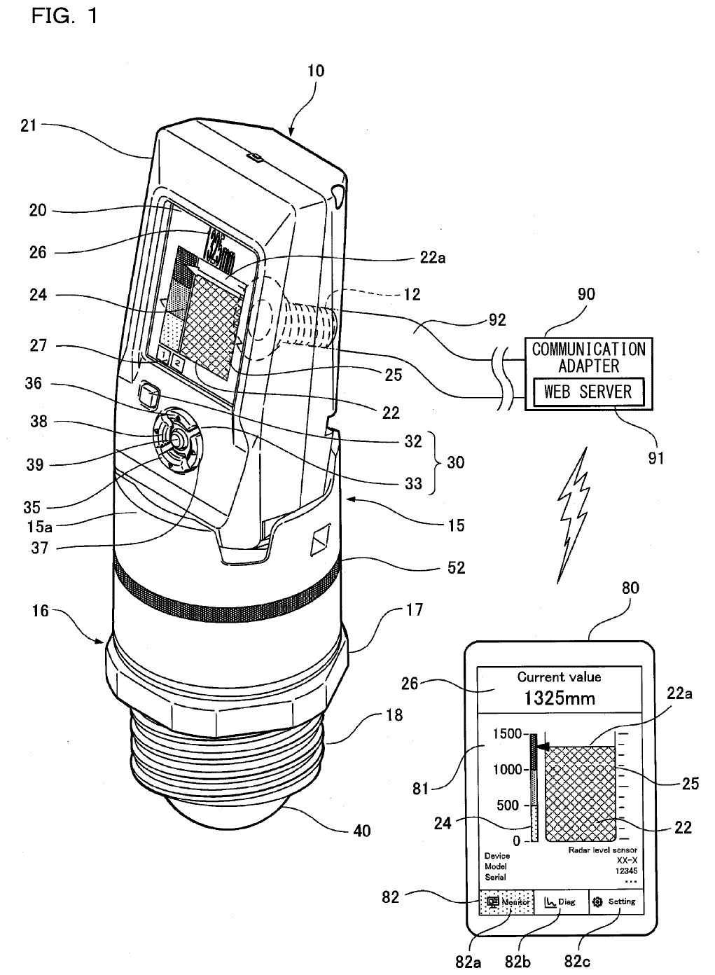

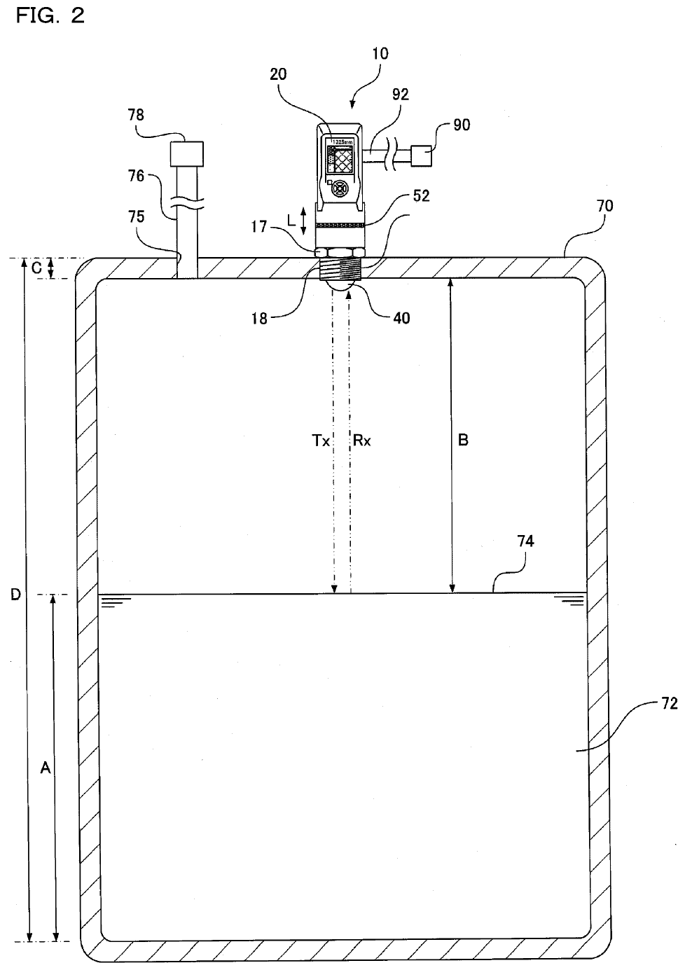

Hereinafter, a level meter system 100 including a level meter 10 as an example of an embodiment according to the invention will be described with reference to the drawings. FIG. 1 is a diagram schematically illustrating the level meter system 100 of the present embodiment. FIG. 2 illustrates a state where the level meter 10 of FIG. 1 is attached to a container 70 that contains a medium 72. The level meter system 100 includes the level meter 10, a communication adapter 90, and a communication terminal 80. The level meter 10 communicates with the communication terminal 80 via the communication adapter 90. The communication adapter 90 includes a WEB server 91, and the WEB server 91 provides a WEB screen displayed on the communication terminal. Note that, the level meter 10 may include the WEB server 91.

The level meter 10 is a device that measures a level A of the medium 72 (for example, liquid, powder, granular material, and the like) to be measured. The measured level A is a height of an interface 74 of the medium 72 in the container 70. Specific examples of the level A include a distance from a bottom of the container 70 to a liquid level of a liquid contained in the container 70. A measurement axis is set in the level meter 10, and the level meter 10 measures the level A along the measurement axis.

As an example of a usage state of the level meter 10, the container 70 of FIG. 2 contains, for example, a liquid (water, oil, chemical solution, and the like) to be the medium 72 in a liquid treatment facility. For example, the medium 72 in the container 70 is supplied to a liquid treatment process or the like, and thus, the level A of the medium 72 in the container 70 decreases. In addition, the medium 72 is replenished to the container 70, and thus, the level A of the medium 72 in the container 70 rises. For example, a water pouring port 75 is provided in an outer wall (an upper wall in FIG. 2) of the container 70. A water pouring pipe 76 is fluidly connected to the container 70 through the water pouring port 75. The water pouring pipe 76 is connected to a water pouring device 78 (for example, a device including a pump, a valve or the like) provided outside the container 70. The water pouring device 78 is a device for supplying (pouring) the medium 72 into the container 70 from the outside of the container 70. The water pouring device 78 adjusts the amount of water to be poured into the container 70 in accordance with the level A of the medium 72 in the container 70. In addition, the water pouring device 78 stops the water pouring depending on the level A of the medium 72 in the container 70. The water pouring device 78 controls the replenishment of the medium 72 with respect to the container 70 in accordance with the level A of the medium 72 in the container 70 such that the level A of the medium 72 in the container 70, which decreases as the medium 72 is consumed, for example, by the liquid treatment process, is within a predetermined range.

The level meter 10 in FIG. 1 has a housing 15 including a pedestal unit 15a and a terminal unit 21. The pedestal unit 15a is disposed on one end side (lower side) in a longitudinal direction L (a direction of the measurement axis) in the housing 15. The terminal unit 21 is disposed on the other end side in the longitudinal direction L. In FIG. 1, a display unit 20 is provided in the terminal unit 21. In addition, the terminal unit 21 can be separated from the pedestal unit 15a. The pedestal unit 15a has a cylindrical shape, while the terminal unit 21 has a prismatic shape.

The terminal unit 21 may be fixed to the pedestal unit 15a by a fastening screw on a back surface side with respect to the display unit 20. In addition, connection connectors that transmit electric signals between the pedestal unit 15a and the terminal unit 21 may be provided. For example, one of a pair of connection connectors may be provided on the pedestal unit 15a, and the other of the pair of connection connectors may be provided on the terminal unit 21. The pair of connection connectors is connected, and thus, the electric signals can be transmitted and received between the pedestal unit 15a and the terminal unit 21.

A sensor unit 16 is disposed on one end side (lower side in FIG. 1) in the longitudinal direction L of the housing 15. Hereinafter, one end (lower end) of the sensor unit 16 in the longitudinal direction L is referred to as a measurement end portion 40. As illustrated in FIG. 1, a dielectric lens is disposed at the measurement end portion 40. Hereinafter, one end side of the level meter 10 in the longitudinal direction L may be referred to as a lower side, and the other end side in the longitudinal direction L may be referred to as an upper side.

As illustrated in FIG. 2, the sensor unit 16 of FIG. 1 measures the level A of the medium 72 in a state where one end in the longitudinal direction L faces the medium 72. For example, in a case where the level meter 10 measures the height of the liquid level (interface 74) of the liquid, the longitudinal direction L of the level meter 10 is oriented in the same direction as a change direction of the height of the liquid level of the liquid, that is, a vertical direction (height direction or gravity direction).

The level meter 10 in FIG. 2 transmits a radio wave to be a measurement signal Tx from the measurement end portion 40 toward the medium 72. The measurement end portion 40 receives a reflection signal Rx resulting from reflection of the measurement signal Tx at the interface 74 of the medium 72. The level meter 10 calculates the level A of the medium 72 based on the measurement signal Tx and the reflection signal Rx. For example, in a case where measurement using a time of flight (ToF) method is performed, the level meter 10 calculates a distance B from the measurement end portion 40 to the interface 74 based on a difference between the measurement signal Tx and the reflection signal Rx, and calculates the level A based on the distance B. In addition, for example, in a case where measurement is performed by a radar method using a frequency modulated continuous wave (FMCW), the level meter 10 calculates the distance B from the measurement end portion 40 to the interface 74 based on a frequency of a waveform obtained by mixing the measurement signal Tx and the reflection signal Rx, and calculates the level A based on the distance B.

As illustrated in FIG. 1, an attachment screw portion 18 in which a thread is engraved on a surface of a cylinder is provided above the measurement end portion 40 in the sensor unit 16. Further, an attachment portion 17 having a diameter larger than that of the attachment screw portion 18 is provided above the attachment screw portion 18. The attachment portion 17 in FIG. 1 has a nut shape. Note that, the attachment portion 17 is not limited to a nut-like shape as long as the attachment portion has a structure capable of attaching the level meter 10 to an attachment object (such as the container 70 containing the liquid). For example, the attachment portion 17 may have a cylindrical shape in which an anti-slip projection is formed. The anti-slip projection of the attachment portion 17 serves as an anti-slip portion when the level meter 10 is attached or detached (rotationally attached or detached) while rotating around the longitudinal direction L with respect to the attachment object. In addition, an attachment flange for attaching the level meter 10 to the attachment object may be formed instead of the attachment portion 17 and the attachment screw portion 18. In addition, in a case where the attachment flange is formed, the attachment portion 17 and the attachment screw portion 18 may be provided in addition to the attachment flange.

The level meter 10 in FIG. 2 is attached to an upper side of the container 70. An attachment hole 71 is provided on the upper side of the container 70. The attachment hole 71 is a screw hole, and the attachment screw portion 18 of the level meter 10 is screwed into the attachment hole 71. As a result, the level meter 10 is attached to the container 70. For example, a user of the level meter 10 can screw the attachment screw portion 18 into the attachment hole 71 by rotating the nut-shaped attachment portion 17 in a state where a distal end of the attachment screw portion 18 is aligned with the attachment hole 71. Note that, a structure for attaching the level meter 10 to the container 70 is not limited thereto. For example, the attachment hole 71 is not threaded, and a nut is separately screwed to the attachment screw portion 18 exposed to an inside of the container 70. As a result, the level meter 10 may be attached to the container 70. In addition, the level meter 10 may be attached to an attachment bracket which is provided above the container 70 with the upper surface of the container 70 opened by using a nut and the attachment screw portion 18. In addition, a method for attaching the level meter 10 to the container 70 is not limited to the screwing using the attachment screw portion 18, and the thread may not be formed on an outer peripheral surface of the sensor unit 16. For example, a flange may be provided in one or both of the level meter 10 and the container 70, and the level meter 10 may be attached to the container 70 by fixing the flange to the level meter 10 or the container 70 with a bolt.

The display unit 20 is provided on a surface of the terminal unit 21 disposed on an upper side of the housing 15. The display unit 20 preferably includes an active matrix type display device (active matrix display) capable of displaying various types of information. For example, the display unit 20 includes a liquid crystal display (LCD). In particular, the display unit 20 preferably includes an LCD capable of performing color display (display with a plurality of colors).

In addition, the display unit 20 may be a two-wire reflective color liquid crystal display that performs both power transmission and reception and data communication by two power lines. A two-wire display performs data communication by varying a magnitude of a current transmitted through the power line. For example, a consumption current of the power line varies in a range of 4 to 20 mA. A content of data to be transmitted and received is represented by a magnitude of the consumption current. In addition, a reflective display allows the user to visually recognize a display content by external light reflected on a surface thereof. Although the two-wire display can use small power consumption, the two-wire reflective color liquid crystal display can perform various displays with small power consumption. The display unit 20 displays a monitor screen and a setting screen.

The display unit 20 indicates the level A of the medium 72 determined by a level determination unit of the sensor unit 16 on the monitor screen. In FIGS. 1 and 2, a bar indication 22 whose length expands or contracts in accordance with a value of the level A is displayed on the display unit 20. In addition, the display unit 20 also displays a color gauge 24 color-coded with a plurality of colors. A length direction of the color gauge 24 is disposed along an expansion-contraction direction of the bar indication 22. The color gauge 24 includes a plurality of (three in FIG. 1) sections disposed along the expansion-contraction direction of the bar indication 22. The sections of the color gauge 24 correspond to a plurality of level ranges set with respect to the level A of the medium 72, and the level ranges are defined by a plurality of level setting values (for example, thresholds) set with respect to the level A.

The display unit 20 displays a relative position of the level A with respect to the container 70 containing the medium 72 together with the bar indication 22. Specifically, the length of the bar indication 22 expands or contracts in accordance with the value of the level A of the medium 72 in a container icon 25 imitating the container 70. The length of the bar indication 22 relative to a size of the container icon 25 corresponds to a relative position of level A of the medium 72 relative to the entire container 70. Note that, setting information regarding the container 70, such as dimensions, is set on the setting screen.

A bar arrow 22a is displayed at a distal end (upper end) in the expansion-contraction direction of the bar indication 22. The bar arrow 22a indicates a position in the color gauge 24 corresponding to the length of the bar indication 22. The color gauge 24 indicates to which level range the measured level A belongs among the plurality of level ranges defined by the level setting values.

The color gauge 24 includes the plurality of sections. The plurality of sections of the color gauge 24 are divided for the plurality of level ranges. The plurality of sections of the color gauge 24 are disposed along an increasing-decreasing direction of the level A in the display unit 20. The container icon 25 and the bar indication 22 are displayed next to the color gauge 24 (side by side with the color gauge 24). The color gauge 24 is displayed side by side with the container icon 25 and the bar indication 22 on the display unit 20, and thus, a relative position of the level setting value with respect to the container 70 is displayed together with the bar indication 22.

In addition, an auxiliary display unit 26 showing information other than the bar indication 22 and the color gauge 24 is also displayed on the display unit 20. In FIG. 1, a value of the measured level A is displayed as a height numerical value (mm, millimeter notation) on the auxiliary display unit 26.

In addition, the display unit 20 also displays an output state display unit 27. The output state display unit 27 displays a state of the signal line whose output changes depending on a relationship between the measured level A and the level setting value. For example, when a signal is transmitted from a specific signal line in a case where the level A exceeds a threshold determined as the level setting value, a number corresponding to the signal line is displayed on the output state display unit 27. For example, in FIG. 1, the bar arrow 22a indicates an uppermost section among three sections of the color gauge 24. This state of the display unit 20 indicates that two thresholds are set as the level setting values, and the measured level A exceeds both of the two thresholds.

In a case where a signal line that outputs a signal when the measured level A exceeds the threshold is prepared, signals are output from two signal lines corresponding two thresholds in the state of FIG. 1. In FIG. 1, in order to indicate that the signals are output from the two signal lines, numbers (here, “1” and “2”) corresponding to the two signal lines that output the signals are displayed on the output state display unit 27.

In addition, an operation unit 30 is also disposed on the same surface of the terminal unit 21 as an outer surface on which the display unit 20 is disposed. The operation unit 30 in FIG. 1 is disposed below the display unit 20. The operation unit 30 includes a menu key 32 and a direction key 33. In addition, the direction key 33 includes an up key 36 and a down key 35 arranged along the longitudinal direction L. In addition, the direction keys 33 include a left key 38 and a right key 37 arranged in a direction intersecting the longitudinal direction L. Further, a center key 39 is provided at a position surrounded by the up key 36, the down key 35, the left key 38, and the right key 37 in the direction key 33. The display of the monitor screen and the setting screen can be switched by the operation unit 30.

As illustrated in FIG. 1, an indicator lamp 52 is provided on an outer peripheral surface of the pedestal unit 15a connected to a lower side of the terminal unit 21. A lighting state of the indicator lamp 52 changes in accordance with the measured level A of the medium 72. The user can roughly know the state of the medium 72 by visually observing the lighting state of the indicator lamp 52. In FIG. 1, the indicator lamp 52 is disposed between the terminal unit 21 and the sensor unit 16. The indicator lamp 52 can emit light in various lighting colors (for example, green, yellow, red, and the like). The indicator lamp 52 preferably emits light in the lighting color corresponding to the level range to which the level A measured by the level meter 10 belongs. For example, the indicator lamp 52 may emit light in the same color as a color of the section indicated by the bar arrow 22a in the color gauge 24 color-coded by the plurality of colors for the sections.

A connection portion 12 is provided on a back surface (a portion opposite to the display unit 20) of the terminal unit 21. As illustrated in FIG. 1, the connection portion 12 has a cylindrical shape protruding from the back surface of the terminal unit 21. The connection portion 12 is a terminal for inputting and outputting a signal to and from the level meter 10 from the outside. In addition, power may be input to the level meter 10 from the outside through the connection portion 12. The connection portion 12 may include a plurality of signal lines or a plurality of terminals. For example, signals may be output to the outside from different signal lines or different output terminals depending on the level range to which the measured level A belongs.

A communication cable 92 is connected to the connection portion 12. The communication cable 92 connects the communication adapter 90 provided outside the container 70 and the level meter 10. A signal indicating the level A of the medium 72 measured by the level meter 10 is transmitted (output) to the communication adapter 90 via the communication cable 92. The communication adapter 90 receives a signal of a first communication protocol output from the level meter 10, for example, a signal for IO-Link (registered trademark). The communication adapter 90 transmits a signal of a second communication protocol received by the communication terminal 80, for example, a signal of an Ethernet standard, to the communication terminal 80. Communication between the communication adapter 90 and the communication terminal 80 may be performed by wired communication, but is preferably performed by wireless communication (for example, wireless LAN).

The communication terminal 80 is an external device of the level meter 10, and can display a WEB screen by operating a WEB browser. For example, a smartphone, a tablet device, a personal computer (PC), or the like can be used as the communication terminal 80.

The WEB server 91 included in the communication adapter 90 provides the WEB screen displayed on the communication terminal 80 based on information indicated by the signal output from the level meter 10. There are a plurality of types of WEB screens provided by the WEB server 91. The communication terminal 80 can switch and display the plurality of types of WEB screens. The plurality of WEB screens include, for example, a monitor WEB screen, a diagnosis WEB screen, a setting WEB screen, and the like.

In FIG. 1, a vertically long monitor WEB screen 81 is displayed on the communication terminal 80. The monitor WEB screen 81 indicates the level A measured by the level meter 10. The monitor WEB screen 81 includes a bar indication 22, a bar arrow 22a, a color gauge 24, a container icon 25, an auxiliary display unit 26, and the like similar to the display unit 20 of the level meter 10. The WEB screen displayed by the communication terminal 80 includes a switching tab group 82, and the switching tab group 82 in FIG. 1 includes a monitor WEB screen tab 82a, a diagnosis WEB screen tab 82b, and a setting WEB screen tab 82c. In FIG. 1, the monitor WEB screen tab 82a is in a selected state. Another tab included in the switching tab group 82 is selected, and thus, the communication terminal 80 displays the WEB screen corresponding to the selected tab.

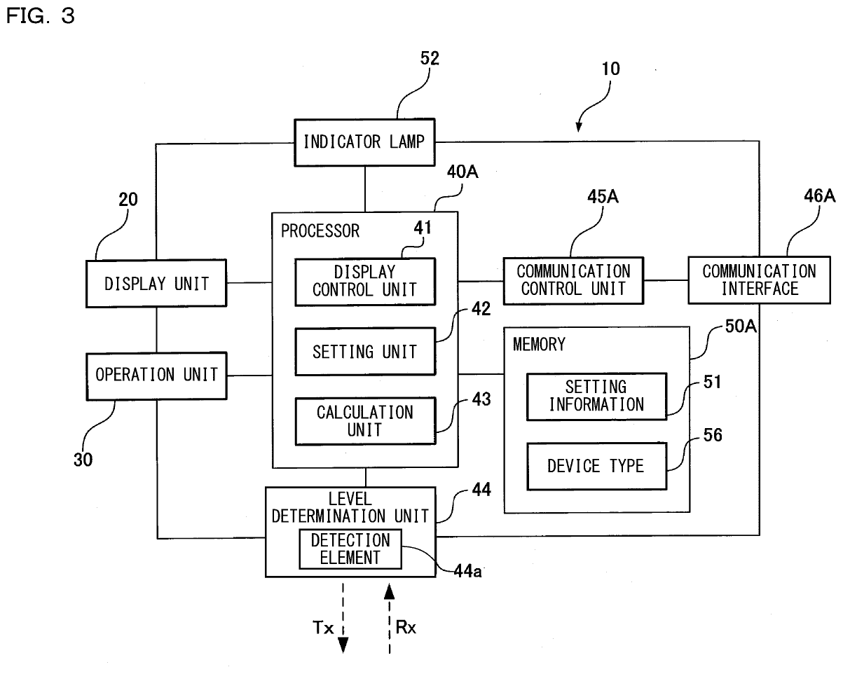

Next, a relationship between the components of the level meter 10 will be described with reference to FIG. 3. FIG. 3 is a block diagram schematically illustrating an example of the relationship between the components of the level meter 10. As illustrated in FIG. 3, the level meter 10 includes the display unit 20, the operation unit 30, a processor 40A, a level determination unit 44, a communication control unit 45A, a communication interface 46A, a memory 50A, and the indicator lamp 52. The processor 40A is connected to the display unit 20, the operation unit 30, the indicator lamp 52, the level determination unit 44, the communication control unit 45A, and the memory 50A. The processor 40A includes a display control unit 41, a setting unit 42, and a calculation unit 43. The display control unit 41 controls display of the display unit 20 (monitor screen, setting screen, and the like) and the indicator lamp 52. The setting unit 42 updates the operation of the level meter 10 and the information regarding the container 70 according to an instruction of the user, a measurement result of the level, and the like. The calculation unit 43 performs various calculations in the level meter 10.

The processor 40A realizes various functions by reading and executing program data stored in the memory 50A. Although program data for realizing functions of the display control unit 41, the setting unit 42, and the calculation unit 43 is also stored in the memory 50A, in FIG. 3, the display control unit 41, the setting unit 42, and the calculation unit 43 are illustrated in the processor 40A for the sake of convenience. The memory 50A stores setting information 51 and a device type 56 in addition to the program data. The setting information 51 is information regarding the container 70 (for example, dimensions).

The setting information 51 can be updated according to the instruction of the user. For example, the operation unit 30 receives an operation input for setting the setting information on the setting screen, the setting unit 42 determines the updated setting information 51 according to the operation input, and the updated setting information 51 is stored in the memory 50A. The device type 56 is information indicating what type of device the level meter 10 itself is, and for example, a numerical value corresponding to a model number (model, “XX-X” in FIG. 1) of the level meter 10 itself is stored as the device type 56 in the memory 50A. In addition, the device type 56 may include a manufacturing number (serial, “12345” in FIG. 1) assigned to an individual level meter 10.

The communication control unit 45A controls communication between the level meter 10 and an external device. The communication control unit 45A generates a signal for communication conforming to the first communication protocol, for example, an IO-Link (registered trademark) standard. The signal generated by the communication control unit 45A is transmitted to the communication cable 92 connected to the connection portion 12 of the level meter 10 via the communication interface 46A. The signal transmitted from the level meter 10 includes the setting information 51 and the device type 56 stored in the memory 50A, the information of the level A determined by the level determination unit 44, and the like. In addition, the communication interface 46A receives a signal transmitted from the outside, and the communication control unit 45A converts the signal received by the communication interface 46A into a format suitable for processing in the processor 40A and inputs the signal to the processor 40A.

The level determination unit 44 includes a detection element 44a that generates a detection signal in accordance with the level A of the medium 72 in the container 70. The detection element 44a is, for example, an antenna-integrated Monolithic Microwave Integrated Circuit (MMIC). The MMIC is an IC in which a plurality of semiconductor components that perform transmission of radio waves, reception of radio waves, signal processing based on transmitted and received radio waves, and the like are integrated into a single semiconductor device (one chip).

The detection element 44a transmits a radio wave to be the measurement signal Tx, and receives the reflection signal Rx obtained by reflecting the measurement signal Tx at the interface 74 of the medium 72. A combination of the measurement signal Tx and the reflection signal Rx is a detection signal corresponding to the level A of the medium 72. The level determination unit 44 performs signal processing on the measurement signal Tx transmitted by the detection element 44a and the reflection signal Rx received by the detection element 44a, as the detection signals generated by the detection element 44a. A detection waveform related to a distance from an installation position (measurement end portion 40) of the detection element 44a to the interface 74 of the medium 72 and the signal intensity of the reflection signal Rx received by the detection element 44a is acquired based on the detection signal.

For example, in the measurement by the ToF method, the level determination unit 44 calculates the distance B from the measurement end portion 40 of the level meter 10 to the interface 74 based on the difference between the measurement signal Tx and the reflection signal Rx, and determines (calculates) the level A based on the distance B. In addition, in the radar measurement using the FMCW, the distance B from the measurement end portion 40 to the interface 74 is calculated based on a frequency of the waveform obtained by mixing the measurement signal Tx and the reflection signal Rx, and the level A is determined (calculated) based on the distance B.

The measurement signal Tx is reflected at the interface 74 of the medium 72 to become the reflection signal Rx, and the reflection signal Rx has a waveform with a time difference with respect to the measurement signal Tx. This time difference is a value corresponding to the distance B (FIG. 2) from the measurement end portion 40 to the interface 74 of the medium 72. When the measurement signal Tx is a signal (frequency modulation signal) having a frequency that repeatedly increases and decreases with time in a constant pattern, the time difference between the measurement signal Tx and the reflection signal Rx can be calculated from a frequency difference between the measurement signal Tx and the reflection signal Rx. Accordingly, the level determination unit 44 can determine the level A of the medium 72 based on the combination (detection signal) of the measurement signal Tx and the reflection signal Rx and the setting information (such as the height of the container 70) regarding the container 70.

The setting information regarding the container 70 includes, for example, a lower surface distance D from the level meter 10 to a lower surface of the container 70, an upper surface distance C from the level meter 10 to an upper surface of an inside of the container 70 (a thickness of a top plate of the container 70 in FIG. 2), and the like illustrated in FIG. 2. The setting information may be set in advance by the setting unit 42 before the measurement of the level A is started. Note that, a distance from the level meter 10 is, to be precise, a distance from a measurement reference surface (a plane whose distance value is treated as 0) serving as a reference of measurement in the level meter 10. A position of the measurement reference surface is determined in advance before the use of the level meter 10 (for example, at the time of designing the level meter 10). For example, a position where the level meter 10 is attached to the container 70 (a position of an outer upper surface of the container 70 in FIG. 2) is determined as the measurement reference surface. In terms of the position in the level meter 10, a lower surface of the attachment portion 17 (an upper end of the attachment screw portion 18) is the measurement reference surface.

Note that, depending on a measurement environment, the reflection signal Rx may be received by the detection element 44a from an element other than the interface 74 of the medium 72 (for example, a device such as a stirrer provided in the container 70) and from other than the interface 74. In a relationship between the distance calculated by the level determination unit 44 and the intensity of the detection signal (the reflection signal Rx or the signal obtained by mixing measurement signal Tx and reflection signal Rx), it is preferable to obtain a maximum peak corresponding to the distance B from the measurement end portion 40 to the interface 74, but when the reflection signal Rx is received from other than the interface 74, a peak other than the maximum peak is obtained. Such a peak other than the maximum peak is likely to appear mainly in a near region close to the level meter 10 (than the interface 74) and a far region far from the level meter 10 (than the interface 74). Therefore, information of a mask region excluded from a detection target of the level A by the level meter 10 may be set as the setting information 51. For example, in order to exclude the near region close to the level meter 10 from the detection target, a near boundary on a side close to the level meter 10 in a range to be the detection target of the level A may be set. In addition, in order to exclude the far region far from the level meter 10 from the detection target, a far boundary on a side far from the level meter 10 in the range to be the detection target of the level A may be set.

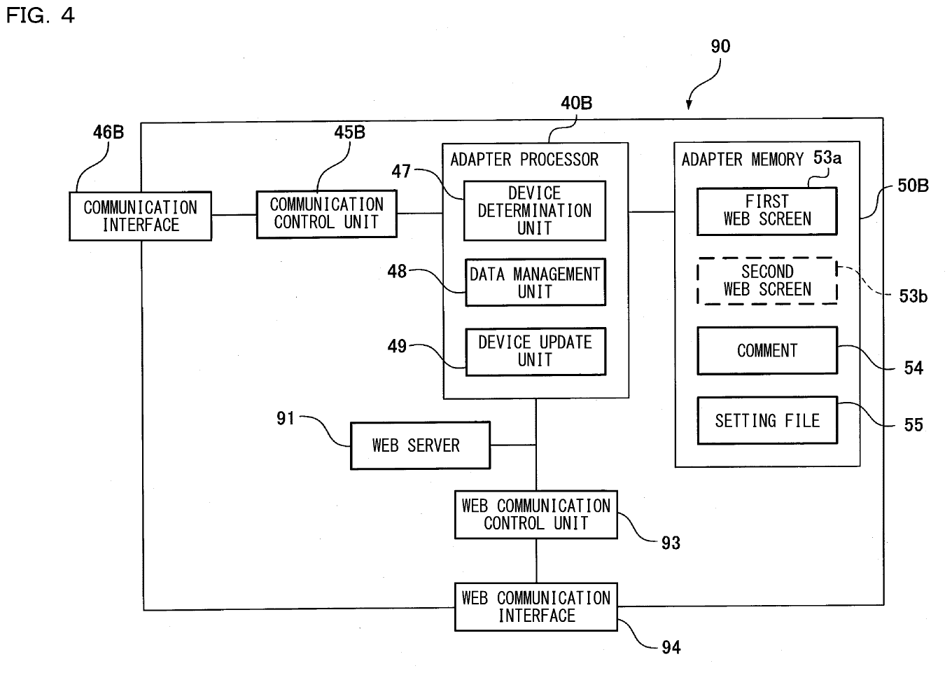

Next, a relationship between components of the communication adapter 90 will be described with reference to FIG. 4. FIG. 4 is a block diagram illustrating the relationship between the components included in the communication adapter 90 of the level meter 10. The communication adapter 90 includes the WEB server 91. The communication adapter 90 further includes an adapter processor 40B, a communication control unit 45B, a communication interface 46B, an adapter memory 50B, a WEB communication control unit 93, and a WEB communication interface 94.

The communication interface 46B of the communication adapter 90 receives the signal of the first protocol transmitted from the communication interface 46A of the level meter 10 through the communication cable 92. The communication control unit 45B of the communication adapter 90 converts the signal of the first protocol into a format suitable for processing in the adapter processor 40B, and inputs the converted signal to the adapter processor 40B.

The adapter processor 40B is connected to the communication control unit 45B, the adapter memory 50B, the WEB server 91, and the WEB communication control unit 93. The adapter processor 40B includes a device determination unit 47, a data management unit 48, and a device update unit 49.

The device determination unit 47 receives information of the device type 56 from the level meter 10 to determine the device type of the level meter 10. For example, when the device type 56 coincides with information registered in advance as the model number of the level meter 10, it is determined that the device connected to the communication adapter 90 is the level meter 10. Note that, the communication adapter 90 can be connected to a device different from the level meter 10, and when the device type 56 is information corresponding to a device (for example, a safety laser scanner) different from the level meter 10, it is determined that the device connected to the communication adapter 90 is a device different from the level meter 10.

The data management unit 48 manages data (information) transmitted from the level meter 10 and data transmitted to the level meter 10. In a case where it is necessary to update a program for operating the level meter 10, such as firmware of the level meter 10, the device update unit 49 performs update processing of the program.

The adapter processor 40B realizes various functions by reading and executing program data stored in the adapter memory 50B. Although program data for realizing functions of the device determination unit 47, the data management unit 48, and the device update unit 49 is also stored in the adapter memory 50B, FIG. 4 illustrates the device determination unit 47, the data management unit 48, and the device update unit 49 in the adapter processor 40B for the sake of convenience.

The adapter memory 50B stores a first WEB screen 53a, a second WEB screen 53b, a comment 54, and a setting file 55 in addition to the program data. In a case where the device connected to the communication adapter 90 is level meter 10, the first WEB screen 53a is data of a WEB screen displayed on the communication terminal 80. In a case where the device connected to the communication adapter 90 is a device other than the level meter 10, the second WEB screen 53b is data of a WEB screen displayed on the communication terminal 80. Data of the WEB screen is preferably prepared individually for each type of device that can be connected to the communication adapter 90. Accordingly, in a case where there are three or more types of devices that can be connected to the communication adapter 90, three or more WEB screens may be stored in the adapter memory 50B.

The comment 54 is any comment written by the user. For example, the user can write a comment related to the container 70 for which the level A is to be measured, a comment related to the level meter 10 used for measurement, a comment related to the entire level meter system 100, or the like, and can store the comment as the comment 54 in the adapter memory 50B. Note that, the user inputs the comment 54 to the communication terminal 80, and the input comment 54 is transmitted from the communication terminal 80 to the communication adapter 90 to be stored in the adapter memory 50B.

The setting file 55 is a data file in which the setting information 51 stored in the memory 50A of the level meter 10 is described. For example, the user can perform transmission from the communication terminal 80 to the communication adapter 90. The communication adapter 90 can update current setting information 51 to the contents described in the setting file 55 via the WEB server 91. In addition, the communication adapter 90 can store the current setting information 51 as the setting file 55 in the adapter memory 50B of the communication adapter 90 via the WEB server 91.

In a case where the level meter 10 is connected to the communication adapter 90, the WEB server 91 provides the first WEB screen 53a as the WEB screen displayed on the communication terminal 80. The first WEB screen 53a includes the monitor WEB screen 81 showing the level A determined by the level determination unit 44, and diagnosis WEB screen 83 displaying the setting information 51 and a detection waveform in association with each other. In addition, the first WEB screen 53a may include a setting WEB screen 85 for updating the setting information 51. Preferably, data of the monitor WEB screen 81, the diagnosis WEB screen 83, and the setting WEB screen 85 are collected as data of one first WEB screen 53a. The monitor WEB screen 81, the diagnosis WEB screen 83, and the setting WEB screen 85 may be voluntarily switched in one first WEB screen 53a in accordance with an operation of the user (for example, an operation of the switching tab group 82). The data of the first WEB screen 53a includes, for example, an HTML file that describes content included in the WEB screen, a CSS file that designates a layout of the WEB screen, and a JavaScript (registered trademark) file that realizes dynamic display of the WEB screen. The WEB server 91 generates the data of the first WEB screen 53a based on a command of the user transmitted from the communication terminal 80 and the data transmitted from the level meter 10, and stores the data in the adapter memory 50B.

Based on the data transmitted from the level meter 10, the WEB communication control unit 93 acquires level meter information including the level A determined by the level determination unit 44 of the level meter 10, the detection waveform generated by the detection element 44a, and the setting information 51 stored in the memory 50A of the level meter 10. The WEB communication control unit 93 converts WEB browser information including the level meter information and the data of the first WEB screen 53a (data of the monitor WEB screen 81, data of the diagnosis WEB screen 83, and the like) into the signal of the second communication protocol (for example, Ethernet) received by the communication terminal 80. The WEB communication interface 94 transmits the signal of the second communication protocol to the communication terminal 80. The WEB communication interface 94 may be a wireless communication interface. The wireless communication interface performs wireless communication with the communication terminal 80 according to a wireless communication protocol such as a wireless LAN. In the entire communication adapter 90, the measurement data transmitted from the level meter 10 to the communication adapter 90 is converted into data of the WEB screen displayed on the communication terminal 80 and transmitted to the communication terminal 80.

In addition, the WEB communication control unit 93 and the WEB communication interface 94 receive the signal of the second communication protocol transmitted from the communication terminal 80. The signal transmitted from the communication terminal 80 includes a command (request) from the user. A request is processed by the adapter processor 40B and is converted into a command to the level meter 10. The communication control unit 45B and the communication interface 46B of the communication adapter 90 convert a command to the level meter 10 into the signal of the first communication protocol and transmit the signal to the level meter 10. In the entire communication adapter 90, a request for WEB screen data from the communication terminal 80 to the communication adapter 90 is converted into a request for measurement data to the level meter 10 and is transmitted to the level meter 10.

The WEB server 91 provides the first WEB screen 53a including the monitor WEB screen 81 displaying information regarding the level meter 10, the diagnosis WEB screen 83, and the like, and thus, communication with the level meter 10 can be performed from any device (communication terminal 80 such as a tablet device) including the WEB browser. Thus, it is not necessary to prepare a device dedicated to communication with the level meter 10, and communication is facilitated. Note that, an IP address corresponding to the level meter 10 is set on the first WEB screen 53a. Specifically, when the communication terminal 80 communicates with the level meter 10, the communication terminal 80 can communicate with the level meter 10 by accessing the IP address corresponding to the level meter 10 with the WEB browser. In a case where the WEB server 91 provides the first WEB screen 53a having different IP addresses to different level meters 10, it is also possible to access a plurality of level meters 10 from one communication terminal 80 only by switching the IP addresses. Note that, since any device including the WEB browser can access the level meter 10, various users can access the level meter 10. The first WEB screen 53a also includes a content that enables change of the setting (setting information 51 and the like) of the level meter 10, and thus, there is a possibility that another user changes the setting of the level meter 10 determined by a specific user. Therefore, the setting can be changed only by the specific user. For example, in order to enable only a user who knows a password to access the level meter 10, in a case where communication is performed from the communication terminal 80 to the level meter 10 (alternatively, in a case where the user tries to access an element related to the change of the setting of the level meter 10), the communication terminal 80 may be requested to input the password for accessing the level meter 10. A password for collation (a correct password defined as the password for access) is encrypted and stored in advance in the level meter 10 (in particular, the memory 50A). Encryption processing equivalent to the password for collation is performed on the password input from the communication terminal 80, and the password is communicated. The level meter 10 receives an input of the password from the communication terminal 80 and collates the input password with a collation password. In a case where the input password coincides with the password for collation (correct password is presented), the access from the communication terminal 80 to the level meter 10 is permitted. In this case, the setting of the level meter 10 can be changed from the communication terminal 80. In a case where the correct password is not input, the access from the communication terminal 80 to the level meter 10 is denied. Alternatively, even though the access itself is possible, the setting of the level meter 10 may be unchangeable from the communication terminal 80 that has not presented the correct password. Note that, the password for collation may be changeable by a user who knows the password. In a case where the password for collation is changed, the changed password is encrypted and stored in the level meter 10.

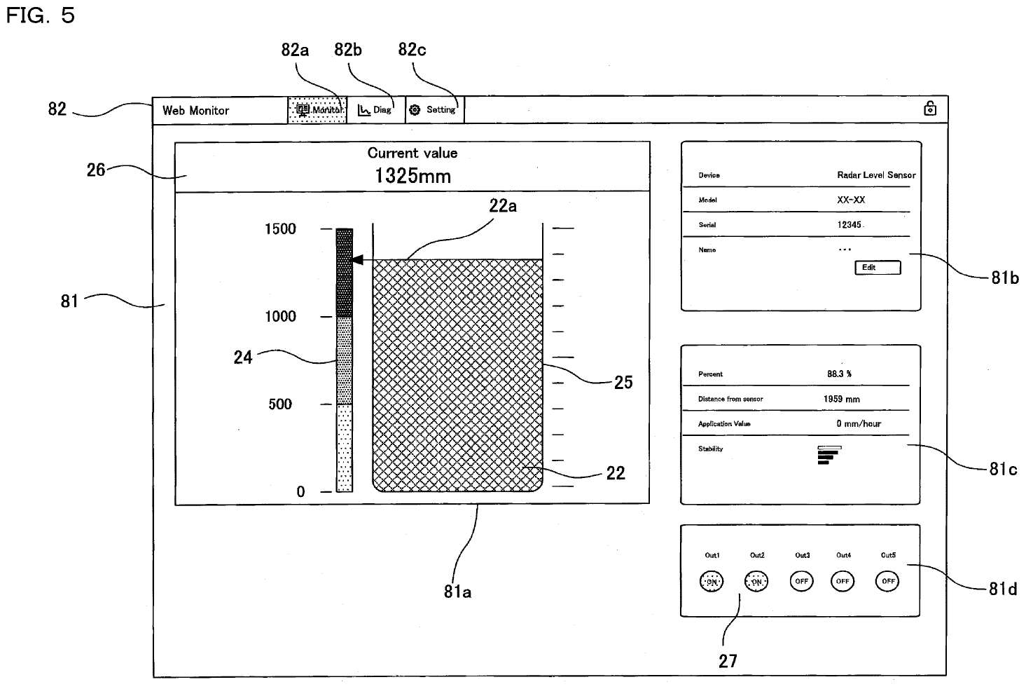

FIG. 5 is a diagram illustrating an example of the monitor WEB screen 81 (horizontally long). In FIG. 1, the communication terminal 80 is disposed vertically, and the monitor WEB screen 81 that is vertically long is displayed. On the other hand, in FIG. 5, the communication terminal 80 is disposed horizontally, and the monitor WEB screen 81 that is horizontally long is displayed. Whether the monitor WEB screen 81 that is vertically long is displayed or the monitor WEB screen 81 that is horizontally long is displayed may be automatically switched depending on an orientation of the communication terminal 80. For example, an acceleration sensor may be provided in the communication terminal 80 such that the communication terminal 80 can detect an orientation (posture) of the communication terminal 80 itself. In addition, the data of the monitor WEB screen 81 may include information (a CSS file or the like) that defines a screen layout in each case of the vertically long case and the horizontally long case.

The monitor WEB screen 81 includes the switching tab group 82, a level display region 81a, a device information display region 81b, an application information display region 81c, and an output state display region 81d. The level display region 81a includes a bar indication 22, a bar arrow 22a, a color gauge 24, a container icon 25, an auxiliary display unit 26, and the like similar to the display unit 20 of the level meter 10.

In the device information display region 81b, display based on information included in the device type 56 stored in the memory 50A of the level meter 10 and information included in the comment 54 stored in the adapter memory 50B of the communication adapter 90 is performed. Specifically, in FIG. 5, a device type name (Device: Radar Level Sensor) of the level meter 10, a model number (Model: XX-XX) of the level meter 10, and a serial number (Serial: 12345) are displayed as the information included in the device type 56. In addition, a name (Name: . . . ) assigned to the level meter 10 by the user is displayed as the information included in the comment 54. The user can change the name on the monitor WEB screen 81. In FIG. 5, an “Edit” button is displayed, and the user operates the “Edit” button by using an input function (for example, a touch panel function of a tablet device) of the communication terminal 80. As a result, the name (Name) becomes editable. Data of a new name edited by the user is transmitted from the communication terminal 80 to the WEB server 91 in the communication adapter 90, and the WEB server 91 stores the data of the new name in the adapter memory 50B, as a part of the comment 54 for the level meter 10.

In the application information display region 81c, supplementary information that is not displayed in the level display region 81a and the device information display region 81b among pieces of information regarding the state of the level meter 10 is displayed. In the application information display region 81c of FIG. 5, a current ratio display (Percent) of the level A with respect to a full amount (100%) of the container 70, a distance (Distance from sensor) from the level meter 10 to the interface 74, and an application value (Application Value) determined by the user are displayed. The application value can be voluntarily determined by the user, and for example, a change amount of the level A within a certain period, a flow rate conversion value of the medium 72 in the container 70, or the like can be displayed as the application value in accordance with the model (information included in the device type 56) of the level meter 10. In FIG. 5, a change amount (mm/hour) of the level A per hour is displayed as the application value. This change amount is 0 when there is no change in level A from one hour ago to a current time. In a case where the flow rate conversion value is displayed as the application value, the change amount of the level A is converted into a flow rate of the medium 72, such as a volume change per hour or a weight change per hour of the medium 72. The converted value (flow rate conversion value) is displayed as the application value. For example, the change amount of the level A converted into the flow rate (amount flowing out of the container 70 or amount flowing into the container 70) of the medium 72 is calculated based on container information such as a volume of the container 70 and data such as a specific gravity of the medium 72. Note that, data necessary for this conversion may be stored as the setting information 51 in the memory 50 in advance. The setting information 51 can be changed on the diagnosis WEB screen 83 and the setting WEB screen 85 to be described later. As the application value, a value obtained by converting the change amount of the level A into a change amount of a volume or the change amount of a weight of the medium 72 may be displayed. Here, the change amount of the volume or the change amount of the weight may be not only a change amount per unit time (flow rate) but also a total change amount within a specific period (integrated value). It is preferable that at least one of the flow rate, the change amount of the volume, and the change amount of the weight can be displayed in a display field of the application value, but these values may be displayed in combination. In addition, stability of a signal is also displayed in the application information display region 81c of FIG. 5. This stability indicates how stably the value of the level A is measured by the level meter 10. In FIG. 5, the stability is indicated by four-stage antenna marks, and the stability is currently in a third stage.

In the output state display region 81d, display similar to that of the output state display unit 27 included in the display unit 20 of the level meter 10 is performed. Since the current value of the level A illustrated in FIG. 5 exceeds two thresholds illustrated in the color gauge 24, signals are output from two signal lines (a part of the plurality of signal lines included in the connection portion 12) corresponding to the two thresholds. The output state display region 81d in FIG. 5 indicates that displays corresponding to the two signal lines that output the signals (here, “Out1” and “Out2”) are in an “ON” state, and the other signal lines (here, “Out3”, “Out4”, and “Out5”) are in an “OFF”′ state.

The user operates the monitor WEB screen tab 82a, the diagnosis WEB screen tab 82b, and the setting WEB screen tab 82c of the switching tab group 82 displayed on the communication terminal 80, and thus, the displays of the communication terminal 80 are switched to the monitor WEB screen 81, the diagnosis WEB screen 83, and the setting WEB screen 85, respectively.

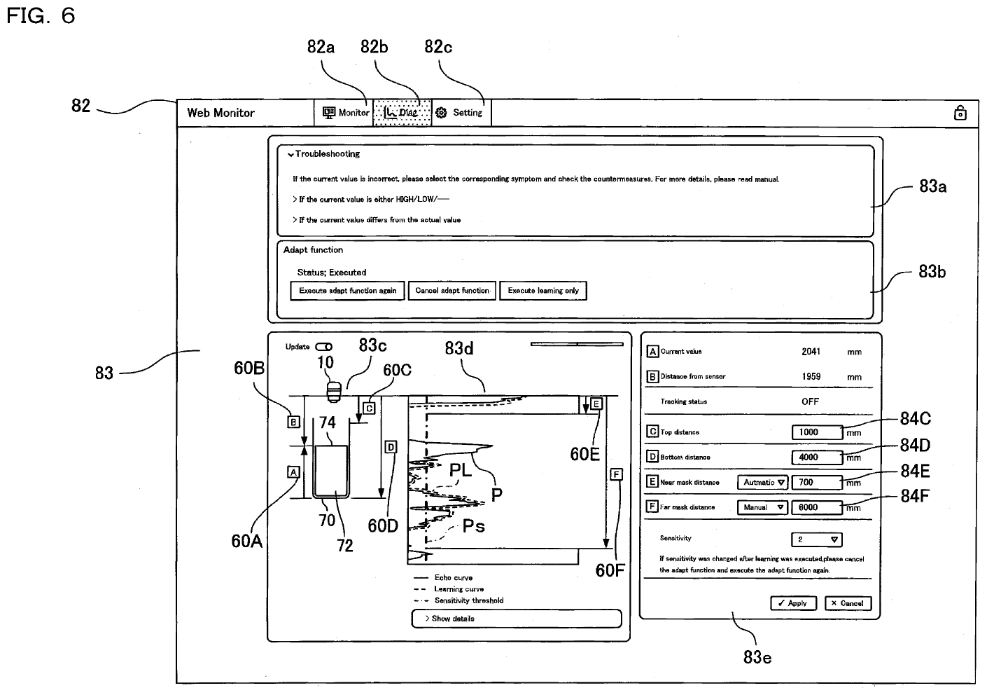

FIG. 6 is a diagram illustrating an example of the diagnosis WEB screen 83 displayed on the communication terminal 80 by operating the diagnosis WEB screen tab 82b. Although the diagnosis WEB screen 83 illustrated in FIG. 6 is a screen that is horizontally long, the diagnosis WEB screen 83 that is vertically long may be displayed in accordance with the orientation of the communication terminal 80. The diagnosis WEB screen 83 includes the switching tab group 82, a troubleshooting display region 83a, an adaptive function display region 83b, a container display region 83c, a waveform display region 83d, and a setting display region 83c.

In the troubleshooting display region 83a, a display for explaining a method for operating the level meter 10 is performed. In a case where a failure occurs in using the level meter 10, such as a case where the user does not know the method for operating the level meter 10 or a case where an intended measurement is not performed, the user can solve the failure (troubleshooting) by performing the operation according to the content displayed in the troubleshooting display region 83a.

The display in the troubleshooting display region 83a illustrated in FIG. 6 is unfolded. In a case where the user needs more detailed troubleshooting, the user can obtain a more detailed description of how the failure can be resolved by unfolding the unfolded display (for example, a mark “>” displayed at the beginning of each sentence is operated). In the troubleshooting display region 83a, explanations related to matters that require attention in using the level meter 10 may be displayed. For example, a sentence prompting appropriate setting of setting information such as the upper surface distance C and the lower surface distance D to be described later may be displayed in the troubleshooting display region 83a. Note that, the display of the troubleshooting may be switched for each work procedure (step) of the user.

In the adaptive function display region 83b, options related to whether or not to execute an adaptive function (adjust function) to be described later are displayed. In FIG. 6, an option of “Execute adapt function again” is selected, and thus, the adaptive function is executed.

In the container display region 83c, display imitating the container 70 and the level meter 10 and display corresponding to the level A determined by the level determination unit 44 are performed. Here, the display corresponding to the level A is performed in the bar indication of which the length expands or contracts in accordance with a measured value of the level A. The bar indication preferably varies in accordance with an actually measured value of the level A measured by the level meter 10. In addition, in the container display region 83c, a level display FIG. 60A, an interface distance FIG. 60B, a container upper surface FIG. 60C, and a container lower surface FIG. 60D are displayed in an overlapping manner.

The level display FIG. 60A is a figure indicating the level A. In FIG. 6, the level display FIG. 60A is represented by a line parallel to a lower surface of the display imitating the container 70, a line parallel to the interface 74 of the display imitating the medium 72, an arrow extending therebetween, and a character “A” attached to the arrow.

The interface distance FIG. 60B is a figure indicating the distance B (interface distance B) from (the measurement reference surface of) the level meter 10 to the interface 74. In FIG. 6, the interface distance FIG. 60B is represented by a line parallel to the measurement reference surface, a line parallel to the interface 74, an arrow extending therebetween, and a character “B” attached to the arrow.

The container upper surface FIG. 60C is a figure indicating the upper surface distance C from (the measurement reference surface of) the level meter 10 to the upper surface of the container 70. In FIG. 6, the container upper surface FIG. 60 C is represented by a line parallel to the measurement reference surface, a line parallel to the upper surface of the container 70, an arrow extending therebetween, and a character “C” attached to the arrow.

The container lower surface FIG. 60D is a figure indicating the lower surface distance D from (the measurement reference surface of) the level meter 10 to the lower surface of the container 70. In FIG. 6, the container lower surface FIG. 60D is represented by a line parallel to the measurement reference surface, a line parallel to the lower surface of the container 70, an arrow extending therebetween, and a character “D” attached to the arrow.

The interface distance B is directly measured by the level meter 10, and the value of the level A of the interface 74 of the medium 72 in the container 70 is obtained by subtracting this value from the lower surface distance D (A=D−B). The level display FIG. 60A, the interface distance FIG. 60B, and the container lower surface FIG. 60D are displayed, and thus, a relationship among the level A, the interface distance B, and the lower surface distance D can be easily visually recognized. In addition, the container upper surface FIG. 60C is displayed, and thus, it is easy to visually grasp that the level meter 10 is disposed above the upper surface of the container 70.

In the waveform display region 83d, display corresponding to the detection waveform related to the distance and the signal intensity, which is acquired by the level determination unit 44 based on the detection signal generated by the detection element 44a of the level meter 10, is performed. The signal intensity of the detection waveform corresponds to the signal intensity of the reflection signal Rx received by the detection element 44a, and the distance of the detection waveform corresponds to the distance between the measurement reference surface of the level meter 10 and the position where the reflection signal Rx is estimated to be reflected.

A detection waveform graph P, which is display corresponding to the detection waveform (Echo curve), is displayed in the waveform display region 83d of FIG. 6. The detection waveform graph P of FIG. 6 is illustrated with the distance on a vertical axis and the signal intensity on a horizontal axis. The waveform display region 83d is displayed side by side with the container display region 83c. An origin of the vertical axis (distance) of the detection waveform graph P in the waveform display region 83d coincides with a height of the measurement reference surface of the level meter 10 in the container display region 83c. The vertical axis of the detection waveform graph P is set as the distance, and thus, a varying direction (height) of the level A coincides with a direction of the vertical axis of the detection waveform graph P. Accordingly, it is easy for the user to visually grasp at which position of the container 70 and how strong the signal intensity is obtained. In addition, a learning waveform PL (Learning curve) is also displayed in the waveform display region 83d. The learning waveform PL is indicated by a broken line in FIG. 6. The learning waveform PL represents an unnecessary waveform that is considered to be derived from other than the level A of the measurement target in the detection waveform graph P. For example, a peak corresponding to the level A is selected by the adaptive function or the like to be described later with respect to a detection waveform including an unnecessary waveform, and thus, the level meter 10 learns, as the unnecessary waveform, a waveform other than the selected peak. The learned content may be stored in the memory 50A. A waveform representing the learned unnecessary waveform is displayed as the learning waveform PL in the waveform display region 83d. In the detection waveform graph P, a waveform similar to the learning waveform PL is excluded from the detection target of the level A. In FIG. 6, a waveform other than the peak corresponding to the level A of the interface 74 is covered with the learning waveform PL. Accordingly, only the peak corresponding to level A is set as the detection target. The detection waveform graph P and the learning waveform PL are displayed in the waveform display region 83d, and thus, the user can confirm whether or not the learning is correctly performed. For example, it is confirmed that the waveform other than the peak corresponding to the level A in the detection waveform graph P is covered with the learning waveform PL as illustrated in FIG. 6, and thus, the user can easily visually grasp that the unnecessary waveform is correctly removed from the detection target by learning.

A near mask region FIG. 60E and a far mask region FIG. 60F are displayed in an overlapping manner from the container display region 83c to the waveform display region 83d. The near mask region FIG. 60E is a figure indicating a near boundary E on a side closer to the level meter 10 in a range where the level A is to be detected by the level meter 10. The detection signal obtained at a distance closer to the level meter 10 than the near boundary E is excluded (masked) from the detection target of the level A. In FIG. 6, the near mask region FIG. 60E is represented by a line parallel to the measurement reference surface of the level meter 10, a line parallel to the near boundary E, an arrow extending therebetween, and a character “E” attached to the arrow.

The far mask region FIG. 60F is a figure indicating a far boundary F on a side far from the level meter 10 in the range where the level A is to be detected by the level meter 10. The detection signal obtained at a distance farther from the level meter 10 than the far boundary F is excluded (masked) from the detection target of the level A. In FIG. 6, the far mask region FIG. 60F is represented by a line parallel to the measurement reference surface of level meter 10, a line parallel to far boundary F, an arrow extending therebetween, and a character “F” attached to the arrow.

The figures such as the near mask region FIG. 60E and the far mask region FIG. 60F may be displayed in at least one of the container display region 83c and the waveform display region 83d. With these figures, the user can easily visually grasp the range to be the detection target of the level A by the level meter 10.

In the setting display region 83e, display corresponding to the setting information 51 is performed. In the setting display region 83e of FIG. 6, displays corresponding to the level A and the interface distance B are also performed. In FIG. 6, the level A and the interface distance B, and the upper surface distance C, the lower surface distance D, the near boundary E, and the far boundary F, which are parts of the setting information 51, are displayed as numerical values (unit: mm).

Further, the setting display region 83e includes an upper surface distance input field 84C, a lower surface distance input field 84D, a near boundary input field 84E, and a far boundary input field 84F as setting input fields for receiving operations of inputting numerical values of the upper surface distance C, the lower surface distance D, the near boundary E, and the far boundary F. The numerical values of the upper surface distance C, the lower surface distance D, the near boundary E, and the far boundary F are displayed in the upper surface distance input field 84C, the lower surface distance input field 84D, the near boundary input field 84E, and the far boundary input field 84F, respectively.

The user inputs new numerical values of the upper surface distance C, the lower surface distance D, the near boundary E, and the far boundary F into the lower surface distance input field 84D, the near boundary input field 84E, and the far boundary input field 84F, respectively, and then applies the inputs (operates the “Apply” button). As a result, the settings of the upper surface distance C, the lower surface distance D, the near boundary E, and the far boundary F are changed.

Here, in a case where the medium 72 is not present in the container 70 (in a case where the container 70 is empty), in order to prevent the reflection signal Rx reflected by the lower surface of the container 70 from being excluded from the detection, the setting of the far boundary F is preferably a value (6000 mm in this case) larger than the lower surface distance D (4000 mm in this case).

Similarly, in a case where the medium 72 is filled to a limit in the container 70 (in a case where the container 70 is full), in order to prevent the reflection signal Rx reflected near the upper surface of the container 70 from being excluded from the detection, the setting of the near boundary E is preferably a value (here, 700 mm) smaller than the upper surface distance C (here, 1000 mm).

When the settings of the upper surface distance C, the lower surface distance D, the near boundary E, and the far boundary F, which are parts of the setting information 51, are changed, the displays of the container display region 83c and the waveform display region 83d are updated in accordance with the changed setting information 51. Here, the displays in the container display region 83c and the waveform display region 83d are preferably scaled in accordance with the changed setting information 51.

The scaling of the displays in the container display region 83c and the waveform display region 83d means changing scales on the displays such that the displays imitating the container 70 and the level meter 10 in the container display region 83c and the waveform display region 83d and the display of the detection waveform graph P remain within a certain range.

For example, when the upper surface distance C and the lower surface distance D are changed, the size of the container 70 is changed, but when the container 70 on the display becomes extremely large or extremely small, it becomes difficult for the user to visually grasp the change in the medium 72 in the container 70. Thus, it is preferable that the size of the container 70 and the like on the display remain within a range of a size that can be easily visually grasped by the user. For example, it is preferable that the scales on the displays are changed (scaled) so as not to fall below a predetermined minimum dimension on the displays in the container display region 83c and the waveform display region 83d or exceed a predetermined maximum dimension on the displays.

In addition, in the setting display region 83e, signal sensitivity can also be set. In FIG. 6, a value of the signal sensitivity is set to “2”, but the user can change the value of the signal sensitivity by selecting a desired value from options prepared in advance by using a pull-down list or directly inputting a numerical value. In a case where the value of the signal sensitivity is changed, a sensitivity threshold Ps (sensitivity threshold) displayed by a one-dot broken line in the waveform display region 83d changes. The level meter 10 excludes signal intensity below the sensitivity threshold Ps from the detection target. Accordingly, when the signal sensitivity is increased, the level meter 10 reacts to a slight signal intensity, and conversely, when the signal sensitivity is decreased, the level meter 10 does not react to some signal intensity.

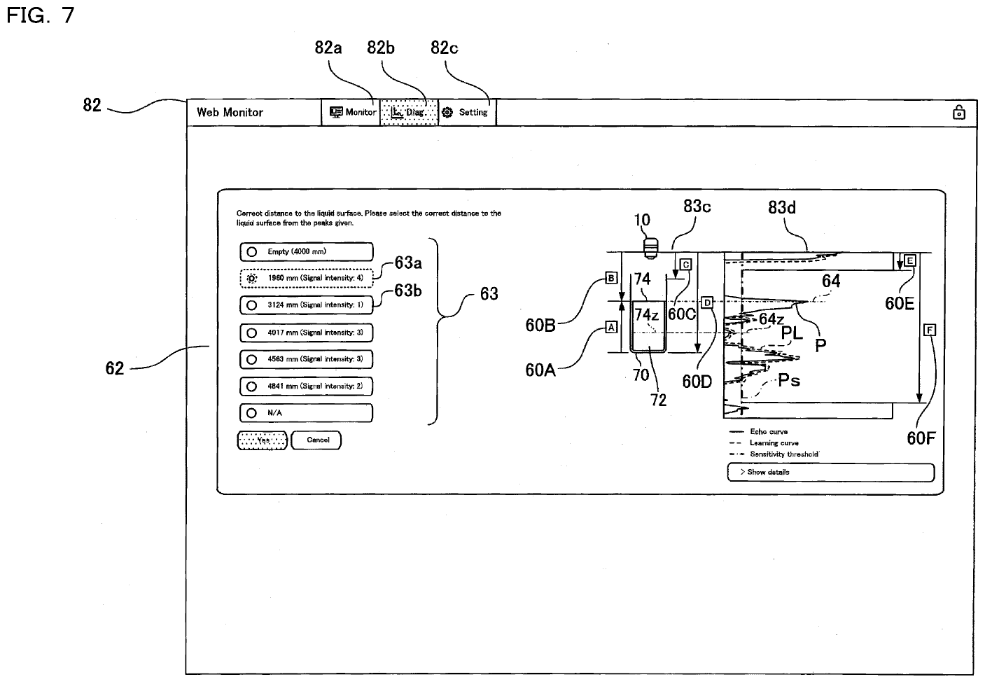

Next, the adaptive function (adjusting function) will be described with reference to FIG. 7. FIG. 7 is a diagram illustrating the display of the communication terminal 80 at the time of execution of the adaptive function. When the adaptive function is executed from the adaptive function display region 83b of the diagnosis WEB screen 83, the display of the communication terminal 80 transitions to an adaptive function screen 62 of FIG. 7.

The adaptive function screen 62 includes the container display region 83c and the waveform display region 83d. The displays of the container display region 83c and the waveform display region 83d are similar to that of the diagnosis WEB screen 83. The adaptive function screen 62 further includes an interface option 63. The interface option 63 is a list of the numerical value (unit: mm) of the distance (distance from the level meter 10) corresponding to the peak appearing in the detection waveform graph P and the signal intensity at the peak. Note that, in the display of the interface option 63, it is preferable that all the detected peaks are displayed without considering the settings (mask settings) of the near boundary E and the far boundary F, the learning waveform PL, the setting of the signal sensitivity, and the like. However, at least a part of these settings may be considered, and for example, a peak that obviously does not correspond to the level A may be removed from the options, and the number of options does not become too large.

The user can adjust which peak corresponds to the level A of the measurement target by selecting the appropriate interface distance B corresponding to the level A of the actual interface 74 in the container 70 among the numerical values listed in the interface option 63. Basically, the peak having the highest signal intensity (the peak of “1960 mm” at which the signal intensity is “4” in FIG. 7) corresponds to the level A of the measurement target. However, since there is a case where the peak having the highest signal intensity does not necessarily correspond to the level A of the measurement target (for example, in a case where there is a structure that easily reflects the measurement signal Tx in the container 70), the user may select an appropriate option from the interface option 63 in consideration of the circumstances of the individual container 70. Here, when all the detected peaks are displayed without considering the mask setting, learning, or the like, even in a case where the peak removed from the detection target by the mask setting, learning, or the like actually corresponds to the level A, the user can select the peak corresponding to the actual level A from the interface option 63. Note that, whenever the user selects an individual option from the interface option 63 on the adaptive function screen 62, the container display region 83c is redrawn such that the position of the interface 74 of the medium 72 changes in accordance with the selected option. FIG. 7 illustrates a state where the option 63a of “1960 mm” is selected. The position of the interface 74 in the container display region 83c is a position representing a distance of 1960 mm from the level meter 10. Accordingly, it is easy for the user to visually grasp how much the distance of the selected option 63a corresponds to in the container 70. In addition, on the adaptive function screen 62, in order to indicate which peak corresponds to the selected option 63a in the detection waveform graph P, a line passing through the peak corresponding to the selected option 63a (a line indicated by an alternate long and short dash line 64 extending in a horizontal direction from the interface 74 in FIG. 7) is displayed in the detection waveform graph P in the waveform display region 83d. The position of the interface 74 in the container display region 83c and the line passing through the peak of the detection waveform graph P in the waveform display region 83d are redrawn whenever an individual option is selected from the interface option 63. For example, in a case where an option 63b having a distance of “3124 mm” is selected, the position of the interface 74 is redrawn so as to be the position represented by a virtual line 742 (two-dot chain line) in the container 70 in FIG. 7 in accordance with the distance of the option 63b. At this time, the level display FIG. 60A and the interface distance FIG. 60B are also redrawn in accordance with the distance of the option 63b. In order to indicate the peak corresponding to the option 63b, the line passing through the peak of the detection waveform graph P is redrawn so as to be a position of a line represented by a two-dot chain line 64z extending in the horizontal direction from the container display region 83c to the waveform display region 83d in FIG. 7.

When the user selects an option considered to be appropriate from the interface option 63 and then operates a “Yes” button, the level meter 10 stores the selected option as the peak corresponding to the level A of the measurement target, and the display of the communication terminal 80 returns to the diagnosis WEB screen 83. The selection of the peak may be stored as data included in the setting information 51. In a case where the user desires to cancel the selection of the peak, the selection of the peak is canceled by the user operating a “Cancel adapt function” button included in the adaptive function display region 83b.

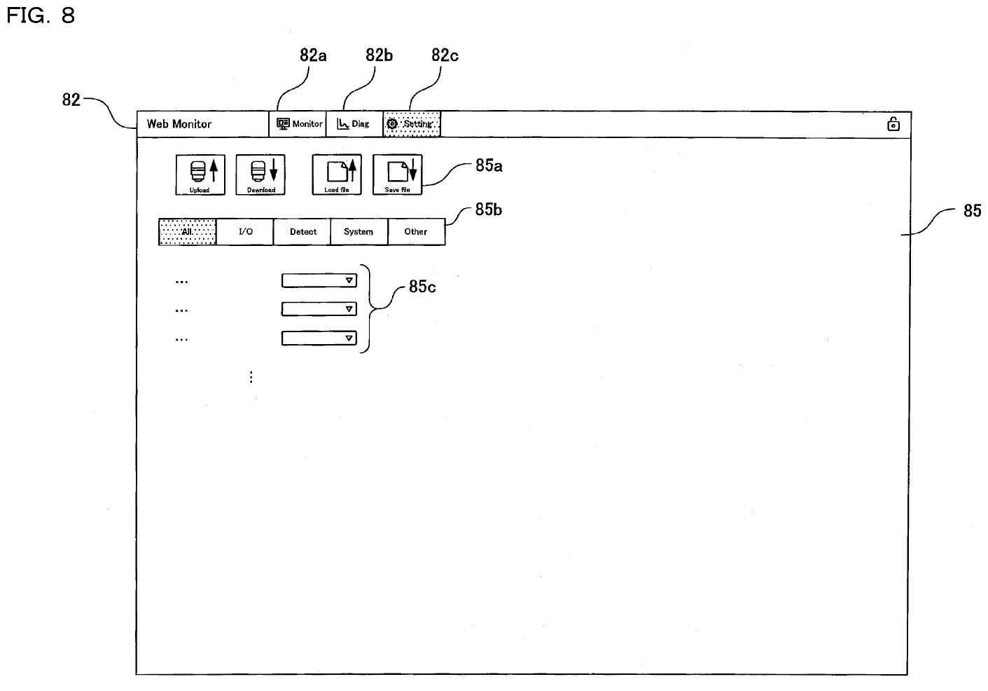

Next, the setting WEB screen 85 will be described with reference to FIG. 8. FIG. 8 is a diagram illustrating an example of the setting WEB screen 85 displayed on the communication terminal 80 by operating the setting WEB screen tab 82c. The setting WEB screen 85 includes a setting information input and output panel 85a, a setting type classification tab 85b, and a setting item group 85c.

The setting item group 85c is an item group for performing various settings related to the operations of the level meter 10. The setting settable in the setting item group 85c includes setting information 51 (upper surface distance C, lower surface distance D, and the like) related to the container 70 settable also on the diagnosis WEB screen 83. Examples of other setting items include settings of a plurality of level setting values (thresholds) related to the level A, PNP/NPN settings (characteristics of a transistor used for an external output and an external input of the level meter 10 are a PNP type or an NPN type), and output logic setting (normal opening or normal closing).

The contents set in the setting item group 85c are transmitted to the level meter 10 and are reflected in the actual operation of the level meter 10 by operating an “Upload” button included in the setting information input and output panel 85a. On the other hand, a “Download” button included in the setting information input and output panel 85a is operated, and thus, the content of the setting item currently applied in the level meter 10 is displayed in the setting item group 85c.

When the user owns a setting file describing a content of a setting item (including the setting information 51 regarding the container 70) settable in the setting item group 85c, the user can transmit the setting file to the WEB server 91 by operating a “Load file” button included in the setting information input and output panel 85a. The WEB server 91 can update the content of the setting item including the setting information 51 stored in the memory 50A of the level meter 10 to the content described in the setting file by receiving the setting file in which the content of the setting item including setting information 51 regarding the container 70 is described. When the contents of the setting items can be collectively updated by using the setting file, the user does not need to operate the setting items one by one in the setting item group 85c, which is highly convenient. In addition, the user can acquire data of the setting file in which the content of the setting item currently applied in the level meter 10 is described by operating a “Save file” button included in the setting information input and output panel 85a. In a case where the user performs the setting that is expected to be repeatedly used, the user can update the content of the setting item by using the setting file by acquiring the data of the setting file at that time, and can omit the operation of the setting item group 85c in a subsequent work.

In the above embodiment, communication is performed from the communication terminal 80 to the level meter 10 via the communication adapter 90 including the WEB server 91. However, the level meter 10 may include the WEB server 91 that provides the WEB screens (monitor WEB screen 81, diagnosis WEB screen 83, and the like) displayable on the WEB browser. When the level meter 10 includes the WEB server 91, communication can be directly performed from the communication terminal 80 to the level meter 10 by using the WEB browser (without using the communication adapter 90).

In the above description, the case where the level meter 10 is connected to the communication adapter 90 including the WEB server 91 has been described. However, a device other than the level meter 10 can be connected to the communication adapter 90. In a case where the device type 56 (FIG. 3) of the device connected to the communication adapter 90 is not the level meter 10, the WEB server 91 provides the second WEB screen 53b (FIG. 4) corresponding to the device other than the level meter 10. The communication terminal 80 can easily communicate with a device other than the level meter 10 by accessing the IP address corresponding to the second WEB screen 53b with the WEB browser.

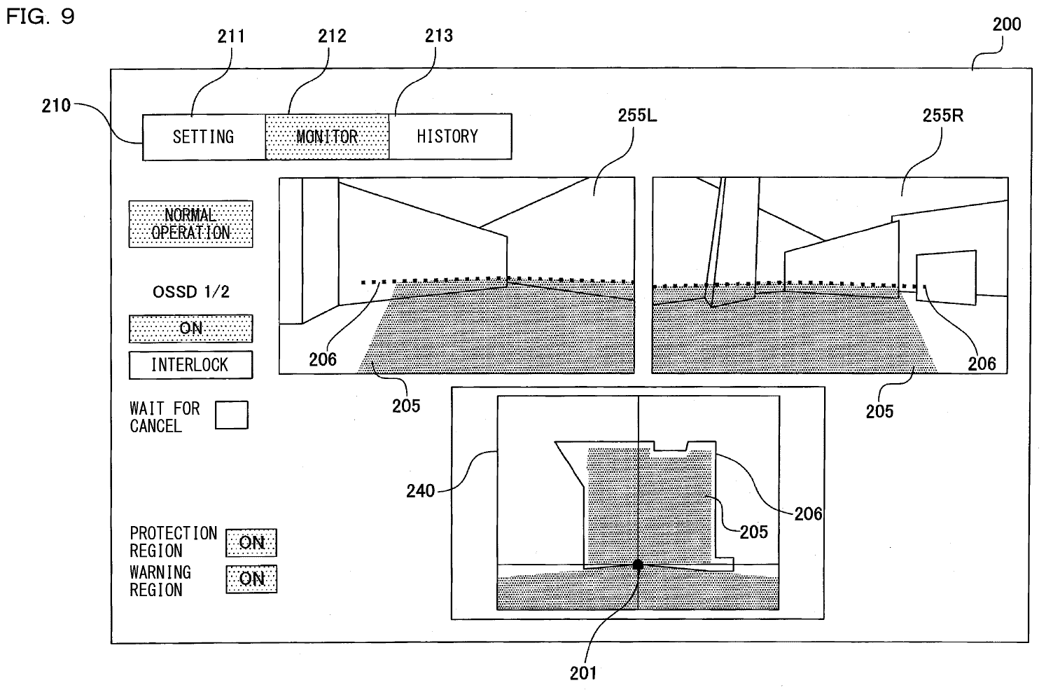

An example of the device other than the level meter 10 is a safety laser scanner. The safety laser scanner is a device that detects entry of a person into a preset region (protection region, warning region, or the like) by using a laser beam. FIG. 9 is a diagram illustrating an example of a WEB screen for the safety laser scanner. In FIG. 9, a monitor screen 200 of the safety laser scanner is displayed.

The monitor screen 200 includes a screen switching tab group 210, a left camera image 255L, a right camera image 255R, and a setting region image 240. The screen switching tab group 210 includes a setting screen tab 211, a monitor screen tab 212, and a history screen tab 213.

The monitor screen tab 212 is selected on the communication terminal 80 communicating with the safety laser scanner, and thus, the monitor screen 200 is displayed. On the setting region image 240 of the monitor screen 200, setting states of a protection region 205 and a warning region 206 set on the setting screen (screen different from the monitor screen 200) transitionable from the setting screen tab 211 are displayed in an overhead view. The protection region 205 extends in front of the safety laser scanner 201, and the warning region 206 covers a range slightly wider than the protection region 205.

The left camera image 255L and the right camera image 255R illustrate images captured by cameras included in the safety laser scanner 201. The left camera image 255L is an image obtained by capturing a left side as viewed from the safety laser scanner 201. The right camera image 255R is an image obtained by capturing a right side as viewed from the safety laser scanner 201. On the left camera image 255L and the right camera image 255R, a range of the protection region 205 is shaded such that the range can be visually recognized where the range is set as the protection region 205 indoors. In addition, a boundary of the warning region 206 is indicated by a broken line in the left camera image 255L and the right camera image 255R such that the range to which the warning region 206 is set can be visually recognized.

When the safety laser scanner 201 detects that a person enters the warning region 206, a warning is issued to the person (alarm sounding, lighting of alarm lamp, and the like). When the safety laser scanner 201 detects that a person enters the protection region 205, safety measures such as stopping a nearby machine are taken so as not to cause danger to the person.

When the ranges of the protection region 205 and the warning region 206 can be visually confirmed from the WEB browser as in the monitor screen 200, a person who visits a facility in which the protection region 205 and the warning region 206 are set can grasp the ranges of the protection region 205 and the warning region 206 in an actual indoor environment in advance, and it is possible to prevent the person from inadvertently entering the warning region 206 to sound an alarm or entering the protection region 205 to stop the machine.

What is claimed is:

1. A level meter comprising:
a detection element that generates a detection signal corresponding to a level of a medium in a container;
a memory that stores setting information regarding the container;
a level determination unit that acquires a detection waveform related to a distance and signal intensity based on the detection signal generated by the detection element and determines the level based on the detection waveform and the setting information;
a display unit that displays a monitor screen showing the level determined by the level determination unit and a setting screen for setting the setting information;
an operation unit that receives an operation input for setting the setting information; and
a WEB server that provides a monitor WEB screen showing the level determined by the level determination unit and a diagnosis WEB screen displaying the setting information and the detection waveform in association with each other.

2. The level meter according to claim 1, wherein
the diagnosis WEB screen includes
a container display region in which displays imitating the container and the level meter and a display corresponding to the level determined by the level determination unit are performed,
a waveform display region in which a display corresponding to the detection waveform is performed, and
a setting display region in which a display corresponding to the setting information is performed.

3. The level meter according to claim 2, wherein the diagnosis WEB screen further includes a troubleshooting display region in which a display for describing a method for operating the level meter is performed.

4. The level meter according to claim 2, wherein displays of the container display region and the waveform display region are scaled in accordance with the setting information.

5. The level meter according to claim 2, wherein
a container upper surface figure, a container lower surface figure, a near mask region figure, and a far mask region figure are displayed in at least one of the container display region and the waveform display region in accordance with the setting information,
the upper surface figure is a figure indicating an upper surface distance from the level meter to an upper surface of the container,
the lower surface figure is a figure indicating a lower surface distance from the level meter to a lower surface of the container,
the near mask region figure is a figure indicating a near boundary on a side close to the level meter in a range to be a detection target of the level by the level meter, and
the far mask region figure is a figure indicating a far boundary on a side far from the level meter in the range to be the detection target of the level by the level meter.

6. The level meter according to claim 5, wherein
the setting display region includes setting input fields that receive operations of inputting numerical values of the upper surface distance, the lower surface distance, the near boundary, and the far boundary, and
the displays of the container upper surface figure, the container lower surface figure, the near mask region figure, and the far mask region figure dynamically change in accordance with the numerical values input in the setting input fields.

7. The level meter according to claim 1, wherein the WEB server receives a setting file describing the setting information to update the setting information stored in the memory of the level meter to contents described in the setting file.

8. A level meter system comprising:
a level meter that includes a detection element that generates a detection signal corresponding to a level of a medium in a container, a memory that stores setting information regarding the container, a level determination unit that acquires a detection waveform related to a distance and signal intensity based on the detection signal generated by the detection element and determines the level based on the detection waveform and the setting information, a display unit that displays a monitor screen showing the level determined by the level determination unit and a setting screen for setting the setting information, and an operation unit that receives an operation input for setting the setting information;
a WEB server that communicates with the level meter and provides a monitor WEB screen showing the level determined by the level determination unit and a diagnosis WEB screen displaying the setting information and the detection waveform in association with each other; and
a communication terminal that communicates with the WEB server, and operates a WEB browser that displays the monitor WEB screen and the diagnosis WEB screen.

9. A communication adapter for a level meter system that relays communication from the level meter to the communication terminal in the level meter system according to claim 8, the communication adapter comprising the WEB server,
wherein the communication adapter
receives a signal of a first communication protocol output from the level meter, acquires level meter information including the level determined by the level determination unit, the detection waveform, and the setting information, and
transmits WEB browser information including the level meter information, data of the monitor WEB screen, and data of the diagnosis WEB screen to the communication terminal according to a second communication protocol received by the communication terminal.

10. The communication adapter for a level meter system according to claim 9, further comprising a wireless communication interface that performs wireless communication with the communication terminal.
